(19) United States
(12) Patent Application Publication
(10) Pub. No.: US 2025/0034909 A1
(43) Pub. Date: Jan. 30, 2025

(54) INTERLOCKING MECHANISM FOR A CABINET

(71) Applicant: SENG ANN ONG, KLANG (MY)

(72) Inventor: SENG ANN ONG, KLANG (MY)

(21) Appl. No.: 18/379,507

(22) Filed: Oct. 12, 2023

(30) Foreign Application Priority Data
Jul. 28, 2023 (MY) PI2023004533

(51) Int. Cl. E05B 65/464

(52) U.S. Cl. CPC E05B 65/464

(57) ABSTRACT

A safety mechanism for ensuring only a single drawer of a cabinet can be opened at any given time, including an elongate member having a plurality of protrusions distributed along a length of the elongate member, and being movable between a locked position and an unlocked position within the cabinet, a plurality of guiding channels, each coupled to one drawer in such a way that a respective protrusion can only enter the guiding channel when the elongate member is in the unlocked position, whereby each guiding channel includes a path profile to move the elongate member between the locked position and the unlocked position via the respective protrusion when a corresponding drawer is in motion, and a plurality of stoppers, each coupled to one drawer for engaging with a respective protrusion when the elongate member is moving towards or in the locked position to prevent a corresponding drawer from movement.

### CROSS-REFERENCE TO RELATED APPLICATION

The instant application claims priority to Malaysia Patent Application Serial No. PI2023004533 filed Jul. 28, 2023, the entire specification of which is expressly incorporated herein by reference.

### FIELD OF THE INVENTION

The invention relates to a cabinet. More particularly, the invention relates to a cabinet with improved interlocking mechanism.

### BACKGROUND OF THE INVENTION

Furniture tip-over incidents pose a significant threat to the safety of children, resulting in serious injuries and even fatalities. These accidents occur when furniture, such as dressers, bookshelves, or television stands, becomes unbalanced and falls onto unsuspecting children. The consequences of these incidents are devastating, ranging from minor cuts and bruises to severe head injuries, fractures, and even asphyxiation. The statistics surrounding furniture tip-overs are concerning, with thousands of children affected each year. The causes of these tragic accidents are complex, including unstable furniture designs, inadequate furniture anchoring or securing, overly heavy items placed on the furniture, and children's natural curiosity and inclination to climb or explore. Additionally, the use of lightweight and unstable materials in furniture manufacturing, cost-cutting measures compromising structural stability, insufficient warning labels, and a lack of awareness among caregivers contribute to the heightened risk.

One potential solution to address the problem of furniture tip-overs is implementing a safety mechanism that allows only one drawer to be opened at a time, while keeping the remaining drawers securely locked. By restricting the movement of multiple drawers simultaneously, the weight distribution remains balanced, preventing the piece of furniture from becoming top-heavy and unstable. This simple yet effective approach can offer an added layer of safety, providing peace of mind to parents and caregivers while ensuring the well-being of children in their immediate environment.

There are a few patented technologies over the prior art relating to such safety mechanism. Of interest in respect to single-opening drawer locking device is CN105863396A. The patent discloses a cabinet comprises multiple drawers arranged vertically and a locking bar. The locking bar is equipped with interconnected locking rods, which move in sync with one another. The side plates of the drawers have structures that limit the movement of the locking rods, creating locking spaces and connected channels. These locking spaces are positioned in front of the channels, with a height difference between the front and rear sections of the channels. The locking rods extend from the locking bar into the channels, causing them to move up and down accordingly when the drawer is opened or closed. As a result, the other locking rods enter or exit the locking spaces, thereby locking or unlocking the remaining drawers. This unique arrangement automatically secures the other drawers when one drawer is opened, preventing accidental sliding and providing enhanced safety.

To secure the position of the locking rod, a mechanical holder device is provided to hold the locking rod in position. Nevertheless, a disadvantage associated with the use of this mechanical holder device is the production of an irritating noise every time the drawer is opened or closed. This noise can be a source of annoyance for users. Furthermore, the mechanical holder device is prone to substantial wear and tear over time due to its mechanical engagement. The continuous friction and movement involved in the drawer's operation can gradually degrade the mechanical components, compromising the durability and effectiveness of the device in the long run.

Accordingly, it would be desirable to provide a safety mechanism that addresses the aforementioned issue and ensures that only one drawer of the cabinet can be opened at any given time. This invention provides a safety mechanism.

### SUMMARY OF THE INVENTION

In a first aspect of the invention, there is provided a safety mechanism for ensuring only a single drawer of a cabinet can be opened at any given time, the safety mechanism comprises an elongate member having a plurality of protrusions distributed along a length of the elongate member, and being movable between a locked position and an unlocked position within the cabinet; a plurality of guiding channels, each coupled to one drawer in such a way that a respective protrusion can only enter the guiding channel when the elongate member is in the unlocked position, whereby each guiding channel includes a path profile to move the elongate member between the locked position and the unlocked position via the respective protrusion when a corresponding drawer is in motion; a plurality of stoppers, each coupled to one drawer for engaging with a respective protrusion when the elongate member is moving towards or in the locked position to prevent a corresponding drawer from movement; and a holding module for maintaining the position of the elongate member while the drawers are stationary; characterised in that the holding module includes at least one magnet to hold the elongate member in its current position.

Preferably, the elongate member can be moved to the locked position when one of the drawers is opened, simultaneously preventing movement of the remaining drawers by engaging the corresponding stoppers with their respective protrusions in the locked position.

Preferably, the elongate member can be partially or fully made of magnetic material.

Preferably, the elongate member may include a magnetic material affixed to its body.

Preferably, the magnet may have a rectangular shape with a width that is substantially the same as that of the elongated member.

In this aspect of the invention, the invention may further comprise a retaining module having a slot for accommodating one of protrusions of the elongate member, whereby the slot is sized to prevent the movement of the elongated member beyond either the locked position or the unlocked position.

Preferably, the elongate member can be slidable within a groove on an inner side wall of the cabinet.

Preferably, the holding module and/or the retaining module can also secure the elongate member within the groove.

Preferably, each guiding channel and each stopper may be both incorporated in one block structure.

Preferably, the holding module may include a bracket for supporting the magnet at a fixed position within the cabinet.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a side see-through diagram illustrating a safety mechanism of a cabinet when all drawers are closed.

FIG. 2 is a side see-through diagram illustrating the safety mechanism when one of the drawers is opened.

FIG. 3 is a schematic diagram illustrating components of the safety mechanism.

FIG. 4 is a schematic diagram illustrating an elongate member of the safety mechanism.

FIG. 5 is a schematic diagram illustrating a retaining module of the safety mechanism.

FIG. 6 is a schematic diagram illustrating a holding module of the safety mechanism.

### DETAILED DESCRIPTION OF THE INVENTION

The invention will now be described in greater detail, by way of example, with reference to the drawings.

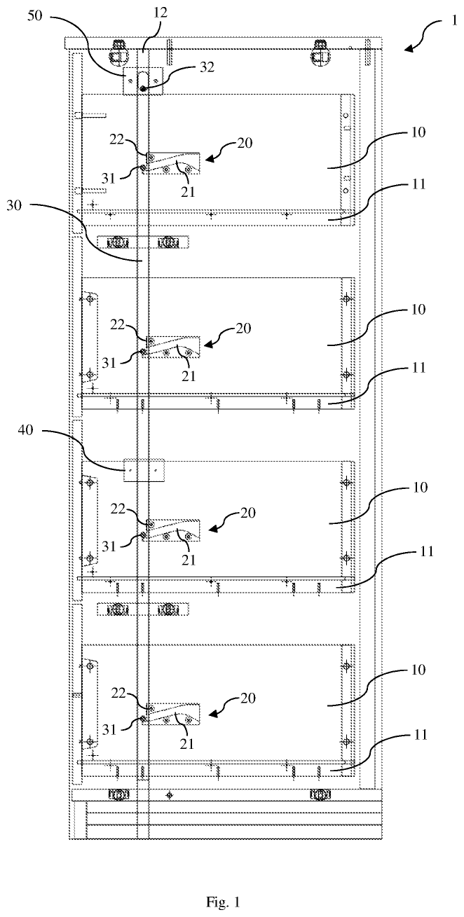

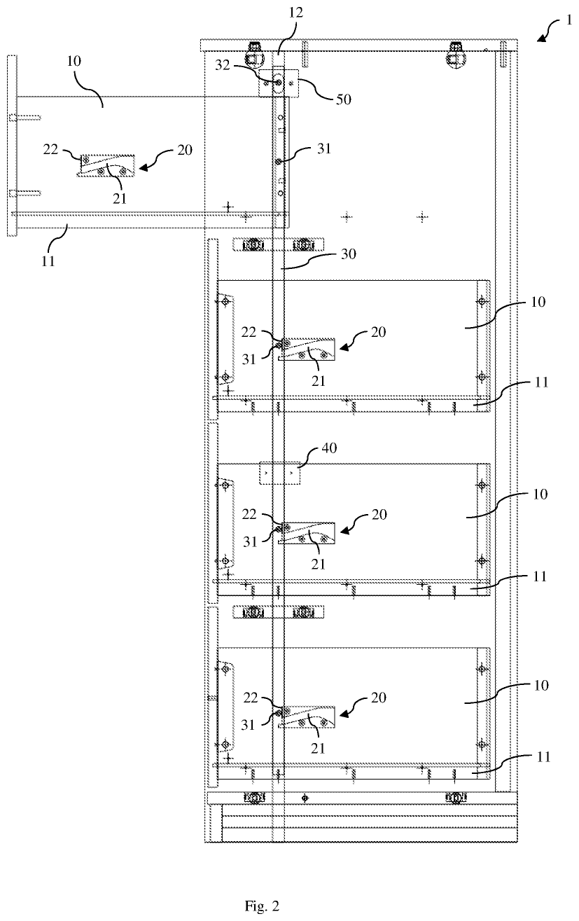

Referring to FIGS. 1 and 2, a cabinet 1 which is installed with a safety mechanism for ensuring only a single drawer 10 of the cabinet 1 can be opened at any given time. The cabinet 1 includes a plurality of drawers 10, preferably arranged one on top of another in a vertical manner. Each drawer 10 includes a sliding mechanism 11 that enables the drawer 10 to move between an opened position where the drawer 10 is accessible and a closed position where the drawer 10 cannot be accessed. The sliding mechanism 11 may include but is not limited to roller slider, under-mount slider, centre-mount slider, ball bearing slider, or any combination thereof.

Preferably, the safety mechanism includes an elongate member 30, a plurality of guiding channels 21, a plurality of stoppers 22, a holding module 40 and a retaining module 50. The elongate member 30 has a plurality of protrusions 31, 32 distributed in a lengthwise manner along the elongate member 30, and being movable between a locked position and an unlocked position within the cabinet 1. In one specific embodiment as shown in FIGS. 1 and 2, a groove 12 is provided on an inner side of a side wall of the cabinet 1. The groove 12 is sized to receive the elongated member 30 in a manner that the elongate member 30 can slide between the locked position and the unlocked position within the groove 12.

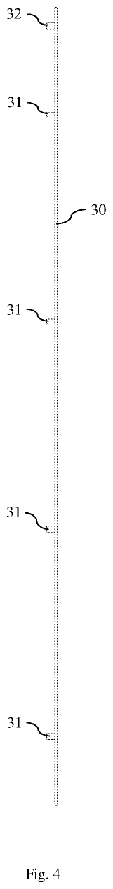

Referring to FIGS. 1 to 3, the holding module 40 and the retaining module 50 prevent the elongate member 30 from disengaging from the groove 12, ensuring its movement is restricted to only between the locked and unlocked positions. While the elongate member 30 is depicted as a one-piece body in FIG. 4, it should be noted that the body can also be constructed using multiple interconnected segments, which exhibit synchronized movements between the locked and unlocked positions. The protrusions 31, 32 can be affixed to the elongate body 30 either through welding or by screw attachment.

Referring back to FIGS. 1 and 2, each drawer 10 comprises a consolidated block structure 20 that incorporates both the guiding channel 21 and the stopper 22. Each guiding channel 21 is positioned adjacent to a corresponding protrusion 31 in such a way that it allows the corresponding protrusion 31 to enter the guiding channel 21 only when the elongate member 30 is in the unlocked position. Preferably, an entrance of the guiding channel 21 is sized only to accommodate the corresponding protrusion 31 when the elongate member 30 is in the unlocked position. Once the elongate member 30 moves away from the unlocked position, the corresponding protrusion 31 is prevented to enter the guiding channel 21. On the other hand, an exit of the guiding channel is sized larger than the entrance to permit the re-entry of the corresponding protrusion 31 from both the locked and unlocked positions. Within each guiding channel 21, a path profile facilitates the movement of the elongate member 30 between the locked and unlocked positions through the corresponding protrusion 31 when a related drawer 10 is in motion. One stopper 22 is preferably positioned above each guiding channel 21, configured to engage with a respective protrusion 31 when the elongate member 30 is moving towards or already in the locked position, effectively preventing the corresponding drawer 10 from opening.

During operation, when a drawer 10 is opened, the interaction between a corresponding protrusion 31 and a corresponding guiding channel 21 forces the elongate member 30 to move upwardly to the locked position. Consequently, the remaining protrusions 31 align themselves adjacent to the stoppers 22, effectively preventing the other drawers 10 from opening. When the opened drawer 10 is closed, the elongate member 30 is moved downwardly to the unlock position, aligning all the protrusions 31 adjacent to the entrance of their corresponding guiding channels 21.

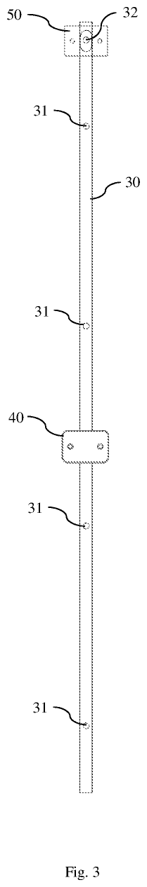

Referring to FIGS. 3 and 6, the holding module 40 is further configured to maintain the position of the elongate member 30 while the drawers 10 are stationary. In other words, the holding module 40 ensures the elongate member 30 stays in the locked position after a corresponding drawer 10 is opened and it keeps the elongate member 30 in the unlocked position when the drawers are closed. To accomplish this, the holding module 40 includes at least one magnet 42 to hold the elongate member 30 in its current position. Preferably, the magnet 42 is of a rectangular shape with a width that is substantially the same as that of the elongate member 30. In one specific embodiment, the holding module 40 is in a form of a bracket having a recess 41 for accommodating the magnet 42 and one or more threaded holes 43 for attachment to the side wall of the cabinet 1 via screws. In this embodiment, the elongate member 30 has the option to be composed of magnetic material, either partially or entirely, enabling the magnet 42 to attract and exert a pulling force on the elongate member 30, effectively holding it in position. Alternatively, the elongate member 30 may be affixed with a magnetic material on its body to have the same or similar effect.

The implementation of the magnetic holding module 40 offers several notable benefits over a mechanical holder. Firstly, it simplifies the assembly process. With the magnet arrangement, there are fewer components to be assembled and adjusted, resulting in a streamlined and efficient assembly. This can save time and effort during the manufacturing or installation process. Additionally, the magnet arrangement ensures noiseless operation. Unlike mechanical holders, which may generate noise due to moving parts or friction, magnets provide a silent and smooth operation. Furthermore, the magnet arrangement experiences less wear and tear compared to mechanical holders. Mechanical holders often have moving parts that can degrade over time, requiring maintenance or replacement.

The properties of the magnet 42 are crucial to strike the right balance between adequate holding force and allowing the elongate member 30 to slide when subjected to external force while one of the drawers is moving. In one specific example, the magnet 42 preferably has a rectangular shape because it provides more area of contact between the magnet 42 and the elongate member 30 when compared to other shape such as circular or triangular. More area of contact offers a more stable sliding movement for the elongate members 30 and also a better control over the distribution of the holding force. The magnetic field strength and the area of contact between the magnet 42 and the elongate member 30 are adjusted to achieve a holding force that is strong enough to maintain the elongate member 30 in position under normal circumstances and yet allowing the elongate member 30 to smoothly move when subjected to external forces applied by a user.

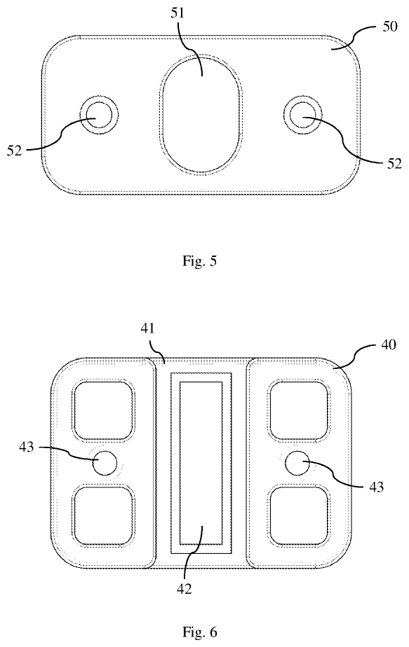

Referring to FIGS. 3 to 5, the retaining module 50 is configured to restrict the movement of the elongate member 30 by incorporating a slot 51 that accommodates one of the protrusions 32 of the elongate member 30. Preferably, the retaining module 50 is positioned at an upper end of the elongate member 30, and therefore the upper most protrusion 32 is inserted into the slot 51. The slot 51 is sized to the movement of the elongated member 30 beyond either the locked position or the unlocked position. The retaining module 50 may include one or more threaded holes 52 for attachment to the side wall of the cabinet 1.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

What is claimed is:

1. A safety mechanism for ensuring only a single drawer of a cabinet can be opened at any given time, comprising:
an elongate member having a plurality of protrusions distributed along a length of the elongate member, and being movable between a locked position and an unlocked position within the cabinet;
a plurality of guiding channels, each coupled to one drawer in such a way that a respective protrusion can only enter the guiding channel when the elongate member is in the unlocked position, whereby each guiding channel includes a path profile to move the elongate member between the locked position and the unlocked position via the respective protrusion when a corresponding drawer is in motion;
a plurality of stoppers, each coupled to one drawer for engaging with a respective protrusion when the elongate member is moving towards or in the locked position to prevent a corresponding drawer from movement; and
a holding module for maintaining the position of the elongate member while the drawers are stationary;
wherein the holding module includes at least one magnet to hold the elongate member in its current position.

2. The safety mechanism according to claim 1, wherein the elongate member is moved to the locked position when one of the drawers is opened, simultaneously preventing movement of the remaining drawers by engaging the corresponding stoppers with their respective protrusions in the locked position.

3. The safety mechanism according to claim 1, wherein the elongate member is partially or fully made of magnetic material.

4. The safety mechanism according to claim 1, wherein the elongate member includes a magnetic material affixed to its body.

5. The safety mechanism according to claim 1, wherein the magnet has a rectangular shape with a width that is substantially the same as that of the elongated member.

6. The safety mechanism according to claim 1, further comprising a retaining module having a slot for accommodating one of protrusions of the elongate member, whereby the slot is sized to prevent the movement of the elongated member beyond either the locked position or the unlocked position.

7. The safety mechanism according to claim 1, wherein the elongate member is slidable within a groove on an inner side wall of the cabinet.

8. The safety mechanism according to claim 7, wherein the holding module or the retaining module further secure the elongate member within the groove.

9. The safety mechanism according to claim 1, wherein each guiding channel and each stopper are both incorporated in one block structure.

10. The safety mechanism according to claim 1, wherein the holding module is in the form of a bracket for supporting the magnet at a fixed position within the cabinet.
